(19) United States
(12) Patent Application Publication
(10) Pub. No.: US 2005/0027550 A1
(43) Pub. Date: Feb. 3, 2005

(54) Process and method for lifecycle digital maturity assessment

(75) Inventors: Thomas P. Pritchard, Howell, MI (US); Trudi M. Waite, Rochester Hills, MI (US); Helmut Christopher Weber, Northville, MI (US); Stephen P. Black, Ann Arbor, MI (US)

Correspondence Address: DOCKET CLERK, DM/EDS, P.O. DRAWER 800889, DALLAS, TX, 75380, US

(73) Assignee: ELECTRONIC DATA SYSTEMS CORPORATION, Plano, TX (US)

(21) Appl. No.: 10/737,215

(22) Filed: Dec. 16, 2003

Related U.S. Application Data
(60) Provisional application No. 60/491,873, filed on Aug. 1, 2003.

(51) Int. Cl. G06F 17/60

(52) U.S. Cl. 705/1

(57) ABSTRACT

An improved process and method for lifecycle digital maturity assessment, including process evaluation and ranking, and the creation of recommendations.

### CROSS-REFERENCE TO RELATED APPLICATIONS

This application claims the benefit of the filing date of U.S. Provisional Patent Application 60/491,873, filed Aug. 1, 2003, which is hereby incorporated by reference.

### TECHNICAL FIELD OF THE INVENTION

The present invention is directed, in general, to product lifecycle management.

### BACKGROUND OF THE INVENTION

It is very important for companies and other entities to be able to evaluate and manage the lifecycles of their products.

Organizations deploy information technology to assist in the development and delivery of their products. To prioritize the investment of their scarce resources, organizations want to understand how successfully they use technology across the entire product lifecycle, so that they can identify where they could better direct their resources.

In order to understand how well a company is utilizing its technology investment, it is necessary to:
establish relative benchmarks of what other companies have achieved
uncover and categorize what technology they deployed in support of their accomplishments
interpolate what might be possible for another company under similar conditions

The need for relative measures requires that vast databases of cross-referenced operational and financial metrics to be built, updated, and validated. These are unwieldy to use and maintain; they are quickly out of date.

There is no way to qualify the sophistication, efficiency, and effectiveness of the information technology infrastructure in supporting the product lifecycle without resorting to relative measures.

There is no way to quantify the business benefit that could be realized through further integration and refinement of the technology supporting the product lifecycle without resorting to specific cost reductions.

There is, therefore, a need in the art for a process and method for lifecycle digital maturity assessment.

### SUMMARY OF THE INVENTION

The preferred embodiments provide an improved process and method for lifecycle digital maturity assessment, including process evaluation and ranking, and the creation of recommendations.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a flowchart of a process in accordance with a preferred embodiment; and

FIG. 2 illustrates an example of a business benefit calculation that can be used in the area of productivity gains.

### DETAILED DESCRIPTION OF THE INVENTION

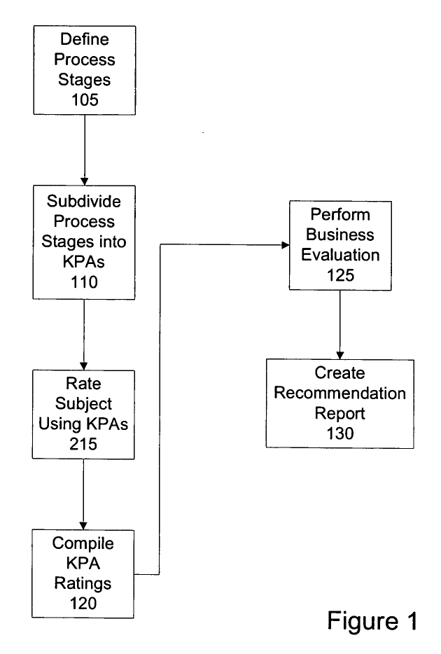

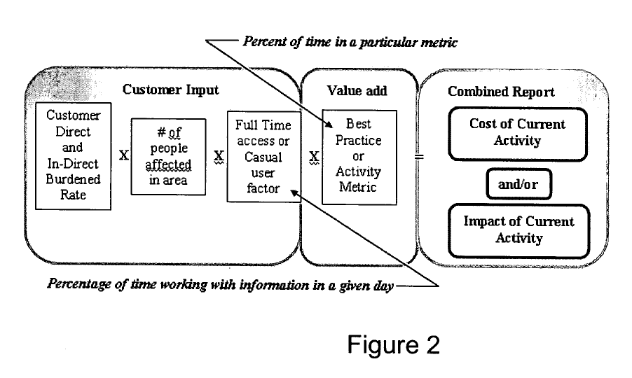

FIGS. 1 and 2, and the discussion below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

The purpose of the Digital Maturity Assessment (DMA) activity is to gain an understanding of the client's specific business climate, order-to delivery processes, and user-level needs and requirements, with the ultimate objective of determining the specific business benefit and value that one or more solutions will provide to the client.

The preferred embodiments include process and method for identifying critical business goals, needs, and issues faced by the client as well as the key business drivers that will allow the client to achieve a sustained competitive advantage in the markets in which they compete.

Examples of the questions one seeks to answer in performing this process include:
Corporate Vision—What does the client want to become? What principles and values does the client aspire to express?
Business Goals—Is the client trying to increase revenue or decrease costs? What milestones have they set? How close is the client to achieving these goals?
Strategic Initiatives—In what direction is the client headed? What are the most important initiatives in place? What other initiatives are planned? Which are budgeted?
Core Competencies—What skills has the client utilized to get this far? What do they do well? Alternatively, where do they need help? What aren't they good at?
Impediments—Where are the client's strategic initiatives falling short? What is keeping the client from achieving their goals? Where do they deviate from Best Practices?
Company Solution Roadmap—What recommendations can the company make to the client in the areas of People, Process, and Technology assistance? In what order should the client deploy a solution?
Business Value—To what degree can a given solution improve individual productivity and process throughput at the client? What dollar savings can the client attribute to the solution?

FIG. 1 depicts a flowchart of a process in accordance with a preferred embodiment. Further details of each step are found in the discussion below.

First, define the product lifecycle process stages for the industry being evaluated (step 105).

Next, subdivide each process stage into Key Process Areas (KPAs) (step 110).

Next, rate the subject within each KPA using the Digital Maturity Model (step 115).

Next, compile the subject's KPA ratings for each lifecycle process stage (step 120).

Next, evaluate the business benefit of improving subject's digital maturity (step 125).

Finally, produce a recommendation report (step 130), to suggest improvements and prioritizations, including prescribing and prioritizing specific solutions.

The process aids in defining absolute measures of the subject's information technology (IT) infrastructure's sophistication, efficiency, and effectiveness, and defines the business benefit that could be realized through further integration and refinement of the IT infrastructure.

One tool used in the assessment process is the Digital Maturity Model. The preferred embodiment uses this model to characterize the level of competency achieved by the target at each phase of the product lifecycle. The target is rated on a scale of 1 to 5 for each phase.

The term “digitization,” as used herein, encompasses the aspects of digital maturity, digital transformation, and the assessment process. The ultimate goal is the transformation of the target company business.

In the Digital Maturity Model, there are five (5) distinct levels of maturity. The general descriptions of these levels are defined as follows:

Initial Level (ad-hoc, immature): At the initial level, the organization typically does not provide a stable environment for developing new products. When an organization lacks sound management practices, the benefits of good integrated product lifecycle management practices are undermined by ineffective planning, reaction-driven commitment systems, process short-cuts and their associated risks, late involvement of key disciplines, and little focus on optimizing the product across its life cycle. Development and management processes are also unpredictable and unstable, because the process is constantly changed or modified as the work progresses or varies from one project to another. Performance depends on the capabilities of individuals or teams and varies with their innate skills, knowledge, and motivations.

Repeatable Level: At the repeatable level, policies for managing a development project and procedures to implement those policies are established. Effective management processes for projects are institutionalized, which allow organizations to repeat successful practices developed on earlier projects, although the specific processes implemented by the projects may differ. An effective process can be characterized as practiced, documented, enforced, trained, measured, and able to improve. Basic project and management controls have been installed. Realistic project commitments are based on the results observed on previous projects and on the requirements of the current project. The project managers and team leaders track costs, schedules, and requirements; problems in meeting commitments are identified when they arise. Product requirements and design documentation are controlled to prevent unauthorized changes. The team works with its clients and OEMs to establish a strong customer-client relationship.

Defined Level: At the defined level, the standard processes for developing new products is documented, these processes are based on integrated product development practices, and these processes are integrated into a coherent whole. Such processes are used to help the managers, team leaders, and development team members perform more effectively. An organization-wide training program is implemented to ensure that the staff and managers have the knowledge and skills required to fulfill their assigned roles. Projects tailor the organization's baseline processes to develop their tailored process, which accounts for the unique characteristics of the project. A well-defined process can be characterized as including readiness criteria, inputs, standards and procedures for performing the work, verification mechanisms (such as team reviews), outputs, and completion criteria. Roles and responsibilities are clearly defined and understood. Because the process is well defined, management has good insight into progress on all projects. Project cost, schedule, and requirements are under control, and product quality is tracked.

Managed Level (Best Practices): At the managed level, the organization establishes metrics for products and processes and measures results. Projects achieve control over their products and processes by narrowing the variation in their process performance to fall within acceptable boundaries. Meaningful variations in process performance can be distinguished from random variation (noise). The risks involved in moving new product technology, manufacturing processes and markets are known and carefully managed. The development process is predictable because the process is measured and operates within measurable limits. This level of process capability allows an organization to predict trends in process and product quality within the quantitative bounds of these limits. When these limits are exceeded, action is taken to correct the situation. As a result, products are of predictably high quality, at or under targeted costs, and on time or ahead of schedule.

Optimized Level (Next Practices): At the optimized level, the entire organization is focused on continuous process improvement. The organization has the means to identify weaknesses and strengthen the process proactively, with the goal of preventing the occurrence of defects. Data on the effectiveness of the development process is used to perform cost benefit analyses of new development technologies and proposed changes to the organization's development process. Innovations that exploit the best-integrated product lifecycle practices are identified and transferred throughout the organization. Product development teams analyze failures and defects to determine their causes. Development processes are evaluated to prevent known types of failures and defects from recurring, and lessons learned are disseminated to other projects. Improvement occurs because of both incremental advances in the existing process and by innovations using new technologies and methods.

The following tables provides a general characterization of the people, process and technology status associated with each of the 5 Digital Maturity Levels:

| | | | | LEVEL 4 | LEVEL 5 |
|---|---|---|---|---|---|
| | | | | Managed | Optimized |
| | LEVEL 1 | LEVEL 2 | LEVEL 3 | (Best | (Next |
| | Initial | Repeatable | Defined | Practices) | Practices) |
| PROCESS | Ad-Hoc | Reusable | Tailored | Predictable | Preventative |
| | Processes | Processes and | Processes | | |
| | | Data | | | |
| | Individual | Standardized | Standardized | Integrated | Integrated |
| | Level | Department | Cross- | across the | across the |
| | Processes | Processes | functional | enterprise | extended |
| | | | processes | | enterprise |
| | | | | | (OEMs and |
| | | | | | clients) |
| | Not | Documented | Institutionalized | Measured | Optimized |
| | Documented | | (Implemented) | | based on |
| | | | | | metrics |
| PEOPLE | Individual | Departmental | Cross- | Enterprise | Extended |
| | | | Functional | Level team | Enterprise |
| | | | Team | | Level Team |
| TECHNOLOGY | Data | Data Shared | Information | Knowledge | Wisdom |
| | Localized | | | | |
| | Data | Internal | External | Extended | Knowledge |
| | Unavailable | Integration | Integration | Enterprise | based |
| | | | | Collaborative | decision |
| | | | | | making |

Outlined below are the nine Functional Categories covered in the Digital Maturity Assessment. Also listed are the Key Process Areas (KPAs) associated with each Functional Category.

Lifecycle Process

| Stages | Key Process Areas (KPAs) |
|---|---|
| 01 - Sales and | Performance |
| Quotation | Priority Setting |
| | Accuracy and Timeliness |
| | Historical Data |
| | RFQ Processing |
| 02 - Requirements | Requirements Management |
| and Planning | Requirements Validation |
| | Intellectual Property Management |
| | Product & Portfolio Management |
| | Program Management |
| | Capacity Planning |
| | Knowledge Management |
| 03 - Concept | Concept Generation |
| Engineering | Concept Validation |
| | Visualization/Simulation |
| | Real-time Collaboration |
| 04 - Product | Program & Project Management/Decision Making |
| Engineering | Requirements Traceability/Validation |
| | Visualization/Simulation/Product Data Management/ |
| | Real-Time Collaboration |
| | Change Management |
| 05 - | Tool & Fixture Design/Equipment & Die Design |
| Manufacturing | Process Planning |
| Engineering | Plant Layout/Work Cell Design/Ergonomics |
| | Throughput Optimization |
| | Computer Aided Machining/Welding/Robotic |
| | Programming |
| 06 - Product Test | Importance to Company |
| and Quality | Advanced Quality Planning |
| | Problem Review and Analysis |
| | Quality Throughout Lifecycle |
| 07 - | Asset Management Productivity |
| Manufacturing | Manufacturing Reliability |
| Production | Material Movement |
| | Inventory Management |
| | Demand Management |
| | Process Technology |
| 08 - Distribution | Planning |
| and Logistics | Warehouse/Distribution Management |
| | Supply-Chain Performance |
| | Delivery Process |
| 09 - Warranty | Importance to Company |
| Management | OEM/Supply-Chain Relationships |
| | Problem Analysis |
| | Support Infrastructure |

Following is an overview of the engagement process. In the planning stage, the objective is preparations, and activities include interviewing the project sponsor, identifying the participants, and prioritizing and setting up interviews. The planning stage will produce an engagement plan and an interview schedule.

In the digital audit stage, the objective is data collection, and activities include identifying core competencies, and identifying impediments and improvement opportunities. The digital audit stage will produce a review with the project sponsor, and a review and followup with management.

In the analysis stage, the objective is the formulation of recommendations, and activities include identifying gaps, defining initiatives, estimating business values, and developing a solutions pyramid. The results of the analysis stage are a status assessment chart, a maturity model spider chart, a value justification, and a solutions pyramid.

In the presentation stage, the objectives are a review of findings and a discussion of the next steps, and activities include reviewing results with the sponsor, a final presentation to management, and discussion and action on next steps. The presentation step produces a presentation and a white paper.

At the conclusion of the activity, the company will deliver the results in the formats described in the following sections.

The Wall Chart (a document measuring approximately 2 ft.×3 ft.) summarizes what was discovered during the Status Assessment portion of the activity. It graphically depicts how the methodology maps the client's Business Goals, Strategic Initiatives, and Core Competencies to the Impediments standing in the way of their successful, synergistic achievement.

It further maps these Impediments to the business impacts they have, specific solutions (Solutions Consulting Services, Visualization, Document Management, Product Configuration, etc.) that can resolve them, and the Business Drivers (revenue growth, cost reduction, innovation, etc.) that are directly affected by them.

The Recommendation Report goes into great depth concerning the issues touched on by the Wall Chart, and it details the results of the Value Justification activity. This will help the client build a solid business case for moving forward with a solution. A typical Table of Contents for the report is outlined below:

RECOMMENDATION REPORT

```
1.0 Executive Summary
2.0 Assessment Approach
      2.1 The Methodology
      2.2 Assessment Approach and Deliverables
3.0 Your Company Overview
      3.1 Corporate Vision
      3.2 Business Drivers
      3.3 Business Goals
      3.4 Core Competencies and Skills
      3.5 Major Business Impediments
      3.6 Business Impact of Impediments and Employee
      Quotes
4.0 Digital Maturity Model
      4.1 Company Ratings and Spider Chart
      4.2 Gap Analysis
      4.3 Recommended Solutions
      4.4 Other Business Recommendations
5.0 Business Value Justification
      5.1 Methodology
      5.2 Benefits and Value (Qualitative)
      5.3 Cost-Driven Value (Quantitative)
      5.4 Solutions Prioritized by Value and Cost
6.0 Conclusions
```

The client presentation is preferably a PowerPoint presentation to be given at the client's facility. This provides an overview of the Recommendation Report and is produced in conjunction with the sales team.

Based on the assessment findings, develop a series of recommendations is developed along with a Value Proposition that outlines the major areas where the target company can achieve tangible business value. The Value Proposition activity will determine a quantifiable business benefit (NPV, Payback, etc.) by comparing the client against product lifecycle best practices. The value add, mapped along with the target company's input, will uncover the specific areas of impact that, if addressed, will lead to cost savings, manufacturing efficiencies, and productivity improvements. The value proposition will be incorporated into the final report, which will define the problem, the recommended solution, and the potential business benefit the solution will provide.

In order to calculate the Business Benefit, data gathered from the following will be employed: Value Assessment Interviews (Phone and On-Site), Cost Numbers from Finance (as needed), Data Extracted from artifacts (SOP's, Annual Reports, Process/Standards Docs), and Benchmark Metrics obtained from Industry Analysis Reports and Customer Base.

FIG. 2 illustrates an example of a business benefit calculation that can be used in the area of productivity gains. Here, it is seen that the combined report is produced from the customer input and value add.

Finally, the company will prepare a detailed and compelling business case for moving forward with an offering.

Although an exemplary embodiment of the present invention has been described in detail, those skilled in the art will understand that various changes, substitutions, variations, and improvements of the invention disclosed herein may be made without departing from the spirit and scope of the invention in its broadest form. For example:
The lifecycle stages can be consolidated, expanded, or modified any industry.
The KPAs can be consolidated, expanded, or restructured across the nine product lifecycle process stages.
The metrics used to evaluate the KPA scorecards can be realigned across the 5 digital maturity levels, or they could be changed entirely.
The DAPPS Productivity Model can be modified to incorporate new processes and tasks.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

1. A method for lifecycle maturity assessment, comprising:
defining process stages of a business process;
dividing the process stages into key process areas;
rating the business process according to the key process areas to produce key process area ratings;
compiling the key process area ratings;
performing a business evaluation in accordance with the key process area ratings; and
creating a recommendation report corresponding tot eh business evaluation.

2. The method of claim 1, wherein each process stage is associated with specific key process areas.

3. The method of claim 1, wherein the business process is rated on a five-level maturity scale.

4. The method of claim 1, wherein the business process is rated according to a predefined digital maturity model.
